(19) United States
(12) Patent Application Publication
(10) Pub. No.: US 2016/0376899 A1
(43) Pub. Date: Dec. 29, 2016

(54) GUIDE VANE ASSEMBLY ON THE BASIS OF A MODULAR STRUCTURE

(71) Applicant: GENERAL ELECTRIC TECHNOLOGY GMBH, Baden (CH)

(72) Inventors: Michal Tomasz PRUGAREWICZ, Rütihof (CH); Alexander STANKOWSKI, Würenlingen (CH); Ulrich WELLENKAMP, Windisch (CH); Hartmut HÃHNLE, Küssaberg (DE)

(73) Assignee: GENERAL ELECTRIC TECHNOLOGY GMBH, Baden (CH)

(21) Appl. No.: 15/038,873

(22) PCT Filed: Nov. 24, 2014
(86) PCT No.: PCT/EP2014/075406

§ 371 Date: May 24, 2016

(30) Foreign Application Priority Data
Nov. 25, 2013 (EP) 13194254.2

(51) Int. Cl. F01D 9/04; F01D 25/14; F01D 25/12; F01D 25/00

(52) U.S. Cl. CPC F01D 9/042; F01D 9/041; F01D 25/005; F01D 25/14; F01D 25/12; F05D 2230/51; F05D 2230/60; F05D 2240/12; F05D 2240/80; F05D 2230/237; F05D 2230/238; F05D 2300/20; F05D 2230/80; F05D 2260/201; F05D 2260/202

(57) ABSTRACT

The invention relates to a guide vane assembly of a turbomachine based on a modular structure, wherein the guide vane elements include at least an airfoil, an inner platform, an outer platform, wherein the guide vane airfoil and/or platforms have at its one ending provisions for connection of the guide vane elements among each other. The connections of the guide vane elements among each other are configured as a detachable, permanent or semi-permanent fixation with respect to the radial or quasi-radial extension of the airfoil compared to the rotor axis of the turbomachine. The assembling of the airfoil with respect to at least one platform is based on a force-fit and/or a form-fit connection, or on the use of a metallic and/or ceramic fitting surface, or on force closure means with a detachable, permanent or semi-permanent fixation.

### TECHNICAL FIELD

The present invention relates to a guide vane assembly of a turbomachine, particularly a gas turbine, on the basis of a modular structure assembled from at least two removable elements. Basically, this guide vane assembly consists of replaceable and non-replaceable elements, and besides the modular guide vane assembly comprising substitutable and non-substitutable elements.

The guide vane assembly comprises at least an airfoil, an inner platform, an outer platform, wherein the guide vane airfoil and/or platforms have at its one ending provisions for connecting the guide vane elements among each other, wherein the connections of the guide vane elements among each other are configured as a detachable, permanent or semi-permanent fixation with respect to the radial or quasi-radial extension of the airfoil compared to the rotor axis of the turbomachine, wherein the assembling of the airfoil with respect to at least the platform is based on a force-fit and/or a form-fit connection, or the assembling of the airfoil with respect to at least the platform is based on the use of a metallic and/or ceramic fitting surface, or the assembling of the airfoil with respect to at least the platform is based on force closure means with a detachable, permanent or semi-permanent fixation, wherein at least the guide vane airfoil or an alternative basis structure of the airfoil comprises at least one flow-applied outer hot gas path liner, which encases at least one part of the guide vane airfoil.

The detachable or permanent connection comprises force closure means which have bolt or rivet finish, or a HT brazing step, an active brazing step or a soldering step. Additionally, inner and outer platform can be made of one piece or of a composite structure.

Furthermore, inner and outer platform comprise means and/or inserts which are able to resist the thermal and physical stresses, wherein the mentioned means are holistically or on their part interchangeable among one another.

### BACKGROUND OF THE INVENTION

U.S. Pat. No. 7,452,182 B2 relates to a modular guide vane assembly. The vane assembly includes an airfoil portion, an outer platform and an inner platform. The airfoil portion can be made of at least two segments. Preferably, the components are connected together so as to permit assembly and disassembly of the vane. Thus, in the event of damage to the vane, repair involves the replacement of only the damaged sub-components. The modular design facilitates the use of various materials in the vane, including materials that are dissimilar. Thus, suitable materials can be selected to optimize component life, cooling air usage, aerodynamic performance, and costs. Because the vane is an assemblage of smaller sub-components, the individual components of the vane can be more easily manufactured and more intricate features can be included. According to this document, one end of the airfoil can be received within a recess in one of the inner and outer platforms. The assembly can further include a seal provided between the recesses and at least one of the radial endings of the airfoil and the outer peripheral surface of the airfoil proximate to the radial end. As a result, hot gas infiltration or cooling air leakage can be minimized. In such case, one or more of the airfoil segments, the inner platform and/or the outer platform can be made of Intermetallics, Oxide Dispersion Strengthened (ODS) alloys, single-crystal metals, advanced superalloys, metal matrix composites, ceramics or CMC.

Furthermore, the airfoil segments can be brazed or welded along their radial interface at or near the outer peripheral surface so as to close the gaps. Alternatively, the gaps can be filled with a compliant insert or other seal (rope seal, tongue and groove seal, sliding dove-tail, etc.) to prevent hot gas ingress and migration through the gaps, as shown in FIG. 4 of U.S. Pat. No. 7,452,182 B2.

The seal may or may not be secured to at least one of the interface surfaces forming the gap. Yet another possibility is to configure the gaps so as to create a longer and tortuous flow path there. For instance, the interface surfaces of the segments can include one or more steps, as shown in FIG. 5 of U.S. Pat. No. 7,452,182 B2. These and other systems can be used to reduce flow potential through any gaps between airfoil segments.

Aspects of the EP 1 881,156 A2 are related to a guide vane assembly in which at least one of the platforms is equipped with one or more removable platform inserts. These inserts can be used in those areas of the platform, where a risk of failures or damages occurs. If an insert becomes damaged or is destroyed during engine operation, the insert can be replaced easily, and the platform frames and the airfoil can be reused. As a result, the overall life of the vane can be extended. Further, the inserts can be made of materials that can reduce cooling requirements compared to known guide vanes, thereby allowing cooling air to be used for other uses in the engine.

The mentioned inserts can be made of one or more different materials. For example, the inserts can be made of ceramic matrix composites (CMC), such as a silicone-carbide CMC. In one embodiment, the inserts can be made of an oxide-based hybrid CMC system, such as disclosed in U.S. Pat. Nos. 6,676,783; 6,641,907; 6,287,511; and 6,013,592. The inserts can be made of metal, such as a single crystal advanced alloy.

According to an embodiment of said EP-application the inserts are made of the same material as the respective platform frame in which they are received, such as IN939 alloy and ECY768 alloy. The inserts can be made of a material that may or may not have a greater resistance to heat compared to the material of the platform frames. For example, the inserts can be made of a material with a lower heat resistance than the material of the receiving platform frames. The inserts can be made from an inexpensive material so that the costs of a replacement insert would not significantly add to the overall costs over the lifetime of the machine.

US 2006/228211 A1 relates to a modular turbine vane assembly. The vane assembly includes an airfoil portion, an outer shroud and an inner shroud. The airfoil portion can be made of at least two segments. Preferably, the components are connected together so as to permit assembly and disassembly of the vane. Thus, in the event of damage to the vane, repair involves the replacement of only the damaged subcomponents as opposed to the entire vane. The modular design facilitates the use of various materials in the vane, including materials that are dissimilar. Thus, suitable materials can be selected to optimize component life, cooling air usage, aerodynamic performance, and cost. Because the vane is an assemblage of smaller sub-components as opposed to one unitary structure, the individual components of the vane can be more easily manufactured and more intricate features can be included.

U.S. Pat. No. 8 366 398 B1 does not disclose or suggest a shrinking joint.

### SUMMARY OF THE INVENTION

The inventive idea of the present invention leaves the use of typical guide vanes consisting of an airfoil, an inner and an outer platform, also called shroud, made in one piece. Especially by using a guide vane which can be assembled by at least two separate parts, i.e. a separate airfoil and outer platform and a separate inner platform, preconditions are created to provide interchangeability or repairing and/or reconditioning of the identified separate parts, modules, elements without replacing the whole guide vane. It is also possible to use guide vanes of three separable parts, i.e. outer platform, airfoil and inner platform. In a separate process the various parts or modules or elements of the guide vane may be repaired and/or reconditioned.

The modular guide vane of a turbomachine on the basis of a modular assembly comprises preferably a stator side platform, also called “outer platform”, an airfoil and a rotor side platform, also called “inner platform. The guide vane may be comprised at least one airfoil carrier, which forms at least one flow member of the outer platform.

The airfoil and/or the platforms have at its one end preferably mechanical means for the purpose of an interchangeable connection of the mentioned vane elements, wherein the connection of the guide vane elements among each other is based on a permanent or semi-permanent fixation with respect to the airfoil in radial or quasi-radial extension compared to the rotor axis of the turbomachine The assembling of the airfoil in connection with the platforms is preferably based on a force-fit or friction-locked bonding actuated by adherence interconnecting.

Alternatively, the assembling of the airfoil in connection with the platforms is based on the use of a metallic and/or ceramic fitting surface with respect to the fixing guide area of the respective vane elements. Alternatively, the assembling of the airfoil in connection with the platforms is based on force closure means or at least one female connector, but with a detachable or permanent connection, wherein at least the basic airfoil comprises at least one outer hot gas path liner encasing at least one part of the airfoil.

Accordingly, the guide vane comprises an airfoil, having at its one end in radial or quasi-radial direction means for inserting the airfoil end into a recess and/or boost associated with the inner platform for the purpose of a detachable or semi-detachable or permanent or quasi-permanent connection resp. fixation of the airfoil. The fixation can be made by means of a friction-locked actuated by adherence or through the use of a metallic and/or ceramic surface coating, or by a force closure means consisting of bolts or rivets, or by HT brazing, or active brazing, or soldering.

The same proceedings are applied to the airfoil with respect to the outer platform, wherein the inner and outer platform can be made of one piece or can be assembled from number of elements.

According to individual operative requirements or individual operating regimes, the airfoil, the inner and outer platform comprise additional means and/or inserts, being able to resist the thermal and physical stress, wherein the mentioned means and inserts are holistically or on their part interchangeable.

The inserts may be inserted in a force-fitting manner into appropriately designed recesses, in the manner of a push loading drawer with additional fixing means. The upper surface forms the flow-charged zone.

However, it must be ensured that all inner and outer platforms of the guide vanes of the first row are aligned adjacent to each other in circumferential direction, limiting an annular hot gas flow in the area of the entrance opening of the turbine stage.

In case of a detachable fixation between the respective end of the airfoil and the inner platform the inner platform provides at least one recess for inserting the hook like extension or lug of the airfoil, so that the airfoil is fixed at least in the axial and circumferential direction of the turbomachine.

The hook like extension has a cross like cross section which is adapted to a groove inside the inner platform. The recess inside the inner platform provides at least one position for insertion or removal at which the recess provides an opening through, which the hook like extension of the airfoil can be completely inserted only by radial movement. The shape of the extension of the airfoil and the recess in the inner platform is preferably adapted to each other like a spring nut connection.

For insertion or removal purposes it is possible to handle the airfoil only at its radially outwards directed end which is a remarkable feature for performing maintenance work at the turbomachine stage.

It is feasible that the inner platform is detachably mounted to an intermediated piece which is also detachably mounted to the inner structure respectively inner component of the turbomachine stage. Hereto, the intermediate piece provides at least one recess for insertion a hook like extension of the inner platform for axial, radial and circumferential fixation of the inner platform.

Basically, the mentioned intermediate piece allows some movement in axial, circumferential and radial direction with respect to the inner platform. There are some axial, circumferential and radial stops in the intermediate piece to prevent the inner platform from unrestrained movements. By these axial and circumferential stops the guide vane airfoil is supported at the outer and inner platform.

An additional spring type feature presses the inner platform against a radial stop within the intermediate piece, so that the airfoil can be mounted into the outer and inner platform by sliding the airfoil radially inwards from a space above the outer platform liner.

Furthermore, a manner of attaching the airfoil and shell or shell portions, also called outer hot gas path liner, to the inner respectively outer platform comprises, that the radial end of the airfoil can be received in a recess provided in the outer platform. Likewise, the radial end of the airfoil can be received in a recess provided in the inner platform. The mentioned recesses can be substantially airfoil-shaped so as to correspond to the outer contour of the airfoil or airfoil assembly. Thus, the airfoil and airfoil assembly including shell arrangement can be trapped between the inner platform and the outer platform.

Moreover, existing solutions according to the mentioned state of the art in section “Background of the Invention” cover only parts of the object of the present invention. One of the most important solutions of the invention is to provide at least one outer and, if necessary and needed and according to individual operative requirements or different operating regimes, at least one not flow-charged intermediate shell for modular variants of the original airfoil. Function of the airfoil carrier is to carry mechanical load from the airfoil module. In order to protect the airfoil carrier with respect to the high temperature of the hot gas path and different thermal deformation of the airfoil module, an outer and an intermediate shell are applied.

If several superimposed shells are provided, they can be built with or without spaces among one another.

The mentioned shells can be made of at least two segments. Preferably, the components, forming the shell, are connected together so as to permit assembly and disassembly of shell, shell components, airfoil and various components of the guide vane.

The advantages achieved by the invention, especially referring to an outer hot gas path liner, consist in the fact that, as a result of the guide vane base airfoil being combined with an additional associated additional flow-charged element, it is possible to use standardized components to a large extent and to produce guide vanes that are individually and specifically matched to locally varying conditions of use.

It is possible to compensate or to reduce local differences in flow-charge of individual guide vanes.

It is in this way, inter alia, possible to reduce the excitation of oscillations in the rotor blade region. Such use of adding flow-charged parts adaptable to different conditions of use can in particular replace the production and holding in stock of different, geometrically similar components, namely a large number of complete guide vanes that are individually adapted to the particular conditions of use.

In the event of damage to the flow-charged shell, repair involves the replacement of only the damaged subcomponents instead of the entire airfoil. The modular design facilitates the use of various materials in the shell, including materials that are dissimilar. Thus, suitable materials can be selected within the shell components to optimize component life, cooling air usage, aerodynamic performance, and costs.

The flow-charged shell assembly can further include a seal, provided between a recess and at least one of the radial endings of the shell and the outer peripheral surface of the airfoil proximate to the radial end. As a result, hot gas infiltration or cooling air leakage, except when an effusion cooling is provided, can be excluded, if the shell segments can be brazed or welded along their radial interface at or near the outer peripheral surface, so as to close the gaps. Alternatively, the gaps can be filled with a compliant insert or other seal (rope seal, tongue and groove seal, sliding dove-tail, etc.) to prevent hot gas ingress and migration through the gaps. In all cases, the interchangeability of the single shell or shell components is to be assured.

The gap or groove of the radial interface of the single shell components can be filled with a ceramic rope, and/or a cement mixture can be used. An alternative consists in a shrinking shell or shrinking shell components on the airfoil. If in such a case the interchangeability of the shell or shell components is not guaranteed, it must be ensured that the entire airfoil arrangement can be replaced.

Both the inner and the outer platform may be formed similar to the airfoil.

Especially the mentioned inner and outer platform can be made of at least two segments. Preferably, the components forming the outer platform are connected together or to the airfoil and/or shell components so as to permit assembly and disassembly of this outer platform.

The hot gas loaded side of platforms is equipped with one or more fixed or removable inserts. The insert equipment forms an integral coverage or capping with respect to the hot gas loaded area.

The mentioned insert equipment has a coating surface, which is able to resist the thermal and physical stresses, wherein the mentioned equipment comprises inserts that are holistically or on their part interchangeable.

Regardless of the specific manner in which the airfoil or shells are attached to the inner and outer platforms, the hot gases, when used in a gas turbine, must be prevented from infiltrating into any spaces between the recesses in the platforms and the airfoil resp. airfoil shells, so as to prevent undesired heat inputs and to minimize flow losses.

If the airfoil is internally cooled with a cooling medium at a higher pressure than the hot combustion gases, excessive cooling medium leakage into the hot gas path can occur. To minimize such concerns, one or more additional seals can be provided in connection with the shell arrangement. The seals can be at least one of rope seals, W-shaped seals, C-shaped seals, E-shaped seals, a flat plate, and labyrinth seals. The seals can be made of various materials including, for example, metals and ceramics.

Additionally, a thermal insulating material or a thermal barrier coating (TBC) can be applied to various portions of the vane assembly.

The main advantages of the present invention are as follows:
Thermo-mechanical decoupling of modules improves the lifetime of the parts compared to integral design.
Modules with different variants in cooling and/or material configuration can be selected to best fit to the different operating regimes.
The airfoil comprises a single outer shell or an outer shell, assembled from components which can be selected in a manner to optimize component life, cooling usage, aerodynamic performance, and to increase the capability of resistance against high temperature stresses and thermal deformations.
The capping or introduction of various inserts in connection with the inner and outer platform can be selected in a manner to optimize component life, cooling usage, aerodynamic performance, and to increase the capability of resistance against high temperature stresses and thermal deformations.
Airfoil, inner and outer platform, and additional integrated elements can be completed with a selected thermal insulating material or a thermal barrier coating.
The cooling of all above mentioned elements of the vane consists mainly of a convective cooling, with selected superposition or integration of impingement and film/effusion cooling.
The interchangeability of all elements to one another or with equivalent forms is given as a matter of principle.
The fixation of the various elements to one another can be made a) by means of a friction-locked actuated by adherence or through the use of a metallic and/or ceramic surface coating, or b) by force-fit, or c) by form-fit, or d) by a force closure assembling with bolts or rivets, or by HT brazing, active brazing or soldering.
The platforms may be composed of individual parts, which are on the one hand actively connected to the airfoil and shell elements and on the other hand actively connected to rotor and stator.
The modular design of the airfoil facilitates the use of various materials in the shell, including materials that are dissimilar, in accordance with the different operating regimes.
The modular guide vane assembly consists of replaceable and non-replaceable elements, and besides the modular guide vane assembly comprises substitutable and non-substitutable elements.
The outer platform is cast, forged or manufactured in metal sheet or plate. The outer platform is consumable in relation to predetermined cycles and replaced frequently as specified maintenance period and may be mechanically decoupled from the guide vane airfoil, wherein the outer platform may be supplementarily mechanically connected to airfoil carrier using force closure elements, namely bolts. The outer platform may be coated with CMC or ceramic materials.
The guide vane airfoil has a pronounced or swirled aerodynamic profile in radial direction, is cast, machined or forged, comprises additionally additive features with internal local web structure for cooling or stiffness improvements. Furthermore, the guide vane airfoil may be coated and may comprise flexible cooling configurations for adjustment to operational requirements, like baseload, peak-mode, partial load of the turbomachine.
The airfoil carrier is cast, machined or forged and additionally comprises additive features with internal local web structure for cooling or stiffness improvements. Furthermore, the airfoil carrier may be coated and comprise flexible cooling configurations for adaption to operational requirements, like base-load, peak-mode, partial load of the gas turbine.
The inner platform is cast, forged or manufactured in metal sheet or plate. The inner platform is consumable and replaced after specified maintenance periods and may be mechanically decoupled from the guide vane airfoil, wherein the inner platform may be supplementarily mechanically connected to the air-foil carrier using force closure elements, namely bolts. The inner platform may be coated with CMC or ceramic materials.
The spar as sub-structure of the guide vane airfoil or operating directly as sub-structure of the shell assembly is interchangeable, pre-fabricated, single or multi-piece, uncooled or cooled, using convective and/or film and/or effusion and/or impingement cooling structure, having a web structure for cooling or stiffness improvement.
The outer shell and additional intermediate shells are inter-changeable, consumable, pre-fabricated, using single or multi-piece with radial or circumferential patches and using with respect to the sub-structure of the guide vane airfoil a shrinking joint.

### BRIEF DESCRIPTION OF THE FIGURES

The invention shall subsequently be explained in more detail based on exemplary embodiments in conjunction with the drawing. In the drawing:

FIG. 1 shows an exemplary guide vane of a gas turbine;

FIG. 2 shows a cross section through the guide vane;

FIG. 3 shows a cross section through the guide vane comprising an additional flow-applied outer hot gas path liner, also called shell module;

FIG. 4 shows an assembled guide vane in the region of the outer platform, wherein the assembly is made by a brazing and/or frictional connection and/or a mechanical loaded;

FIG. 5 shows an assembled guide vane in the region of the outer platform, wherein the assembly is made by a ceramic bush;

FIG. 6 shows an assembled guide vane in the region of the inner platform, wherein the assembly is made by a ceramic bush;

FIG. 7 shows a platform with inserts or mechanical interlocks optionally sealed by HT ceramics;

FIG. 8 shows a joining technology in the range of guide blade airfoil carrier and outer shell assembly;

FIG. 9 shows a further joining technology in the range of guide blade airfoil carrier and outer shell assembly;

FIG. 10 shows a guide vane concept.

### DETAILED DESCRIPTION OF EXEMPLARY EMBODIMENTS

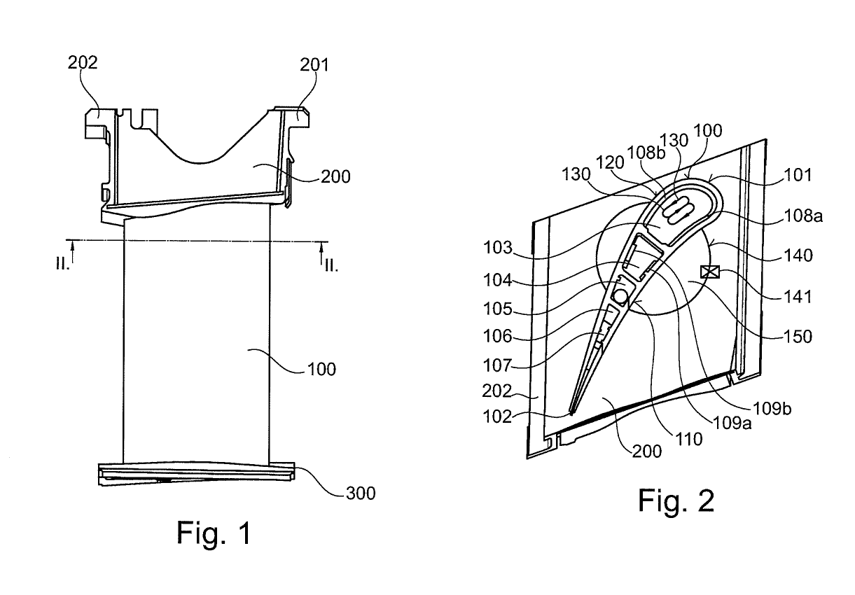

FIG. 1 shows a typically guide vane, which generally has an airfoil 100, an outer platform 200 and an inner platform 300. The outer platform is arranged as a wall element for fixing the guide vane to the inner housing, also called stator, of the gas turbine and forms the outer boundary of a hot-gas duct for the working medium flowing through the turbine. For efficient routing of the flow of the working medium a guide vane row is arranged upstream of a rotor blade row, wherein the guide vanes usually are equipped with a profiled vane airfoil. The guide vane airfoil 100 extends between the vane root, on one side, and a cover plate formed integrally on the vane blade with respect to the other side; this cover plate or platform delimits the hot-gas duct for the working medium in the direction toward the turbine shaft in the region of the respective guide vane row. The guide vane airfoil and the guide vane root form with the cover plate a vane base body of the corresponding guide vane, which is usually, including optionally the inner platform 300, of single-piece design. A vane base body of this type can be produced, for example, by casting, forging, or if appropriate also in single-crystal form.

Accordingly, each guide vane provides a radial outer platform 200, an airfoil 100 and a radial inner platform 300. The radial outer platform contains mounting hooks 201, 202 which are inserted into mounting grooves of the stator component of the first turbine stage (not shown). The inner platform 300 of the guide vane, typically, encloses a gap with the rotor liner through which a purge flow of cooling medium can be injected into the hot gas flow within the gas turbine. In the same way a purge flow of cooling medium is injected through a gap which is enclosed by parts of the stator component, the upstream edge of the outer platform 200 of the guide vane and the outer combustor liner, also called stator liner. Generally, downstream of the outer platform 200 a heat shield (not shown) is mounted inside of the stator component which prevents overheating of the inner faced areas of the stator component in the same way as in case of the outer platform 200.

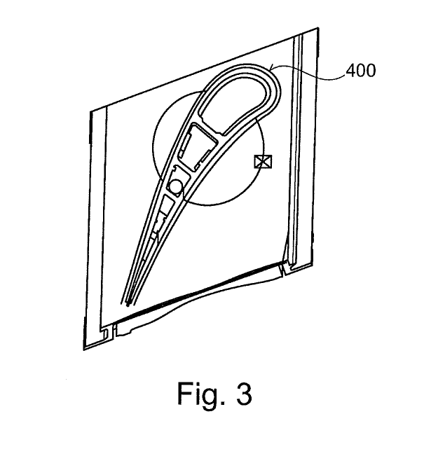

FIG. 2 shows a cross section through the guide vane referring to FIG. 1. A guide vane leading edge side cooling passage 103, intermediate cooling passages 104, 105 and guide vane trailing edge side cooling passages 106, 107 are independently formed between the guide vane leading edge 101 side and the guide vane trailing edge 102 side of the blade effective section. As shown in FIG. 2, heat transfer accelerating elements 108a, 108b, resp. 109a, 109b are internally located between the guide vane outer platform 200 and the inner platform 300 along each guide vane wall on a pressure side 110 resp. suction side 120. Furthermore, these elements 108a, 108b, resp. 109a, 109b may be arranged in an angle, which is inclined to an advancing flow direction of the cooling medium and, in a so-called right ascendant state or left ascendant state. Individual partition walls define respective cooling passages 103-107 to the adjacent partition wall.

For intensive cooling effect heat transfer accelerating elements 108a, 108b, resp. 109a, 109b may be provided. The heat transfer accelerating elements 108a, 108b are located in the guide vane leading edge side cooling passage 103 and are inclined in a right ascendant state to the advancing flow direction of the cooling medium. A heat transfer accelerating element 108a on the pressure side 110 and a heat transfer accelerating element 108b on the suction side 120 may be alternately located in the radial flow direction of the cooling medium. Thus, when the cooling medium jumps over the heat transfer accelerating element 108a on the pressure side 110 and the heat transfer accelerating element 108b on the suction side 120, the cooling medium flows through each space of the adjacent suction side 120 and pressure side 110 and swirls up 130.

At least the assembly between the guide vane airfoil 100 and the outer platform 200 is accomplished by a lug 150 on the one side and a recess 140 on the other side. In the circumferential direction, this connection 140/150 can be arranged as round or polygonal structure. The connection is based on a friction-locked bonding or permanent connection. In addition, means 141 are provided for a locally anchoring of the whole connection. The mentioned adjacent body parts, forming the connection, are provided with a metallic and/or a ceramic fitting surface.

Generally, the means for the purpose of an interchangeable connection of the guide vane elements, namely between airfoil, inner platform, outer platform and optionally flow carrier comprise reciprocal lugs or recesses based on a friction-locked bonding or permanent connection or fixing.

FIG. 3 shows a cross sectional view through the guide vane, comprising an additional flow-applied outer hot gas path liner 400, also called shell module. The flow-applied shell module encases integrally or partially the outer contour of the based guide vane airfoil of the guide vane according to aerodynamic requirements. The partial shell structure is actively connected to the leading edge of the based airfoil of the guide vane, wherein the outer contour of the based airfoil consists of an independent flow-charged part, being actively connected to the leading edge of the airfoil of the guide vane. The flow-charged shell structure encases integrally the outer contour of the based guide vane airfoil, complying with aerodynamic final aims of the vane, or the flow-charged shell structure encases partially the outer contour of the based air-foil in the flow direction of the working medium of the gas turbine, complying with aerodynamic final aims of the guide vane. According to an additional embodiment the based guide vane airfoil comprises inside a supplementary body formed by the configuration of a spar. In place of the based guide vane airfoil can be made a spar as substructure. The shell structure may be formed by the form of an integrally or segmented body. The first shell structure comprises internally a second or intermediate non-flow-charged or partially flow-charged shell structure, complying with aerodynamic final aims of the vane. The two shell liners are adjacent or have an intermediate distance from one another. When the first flow-charged shell structure encases integrally the outer contour of the guide vane airfoil, this shell structure comprises at least two bodies forming completely or partially the outer contour of the based guide vane airfoil. The mentioned bodies, forming completely or partially the outer shell structure, are brazed or welded along their radial interface, and they have radial or quasi-radial gaps, which are filled with a seal and/or ceramic material.

The outer shell is inter-changeable, consumable, pre-fabricated, single or multi-piece with radial or circumferential patches or uses with respect to the sub-structure of the guide vane airfoil a shrinking joint

Furthermore, the intermediate shell or shells are parts of an optional assembly. The mentioned shell(s) are inter-changeable, pre-fabricated, arranged as single or multi multi-piece with radial or circumferential patches, uncooled or cooled (convective, film, effusion, impingement cooling), fabricated as compensator for different thermal expansion of outer shell and spar, and with a cooling shirt with respect to different cooling configurations for optimization operational requirements.

The spar as sub-structure of the guide vane airfoil or of the shell assembly is interchangeable, pre-fabricated or various manufactured, single or multi-piece, uncooled or cooled using convective, film, effusion, impingement cooling, having a web structure for cooling or stiffness improvement.

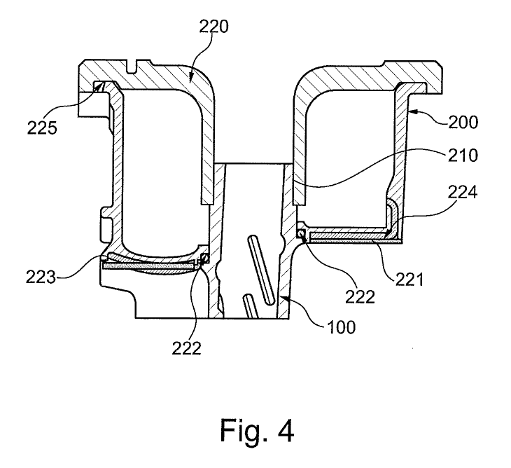

FIG. 4 shows an assembled guide vane in the region of the outer platform, wherein the assembly between airfoil 100 and outer platform 200 resp. airfoil carrier 220 is made by a brazing and/or frictional connection 210. This joint may be mechanically loaded, no absolutely tightness is required. Additionally, the assembled guide vane comprises the following means: The outer platform 200 has an airfoil carrier 220, forming the outer hot gas liner, may be casted, machined or forged. The airfoil carrier may comprise internal local web structure for cooling or stiffness improvement. Material selection and properties are optimized to the individual application. The airfoil carrier 220 comprises flexible cooling configurations provided to functional requirements of the gas turbine with respect to base-load, peak-mode or partial load. Another joint 222 affects the amalgamation between the airfoil 100 and the outer platform 200 on the different levels in radial direction of the guide vane, beyond the above mentioned assembly between airfoil 100 and outer platform 200, made by a brazing and/or frictional connection and/or mechanical loaded 210. The joint 222 is not constructed to absorb mechanical load, but as a sealing connection. A further joint 225 affects the amalgamation between the outer platform 200 and airfoil carrier 220 on the side of the stator. This joint 225 is not constructed to absorb mechanical load, but as a sealing connection. With respect to the hot gases, the flow-applied underside of the outer platform 200 comprises protective liners 221, 223 on the different levels in radial direction of the guide vane. The mentioned liners 221, 223 are made by a brazing and/or frictional connection and/or mechanical loaded 224. The same measures are applied with respect to the inner platform 300 (not specifically shown)

Normally, the platforms 200, 300 and the guide vane airfoil are no consumable parts. In contrast, the mentioned sealing and liners are consumable parts. The airfoil carrier may be consumable, depending on costs.

The airfoil carrier 220 is cast, machined or forged comprising additionally additive features with internal local web structure for cooling or stiffness improvements. Furthermore, the airfoil carrier comprises flexible cooling configurations for adjustment to operational requirements, like base-load, peak-mode, partial load of the gas turbine.

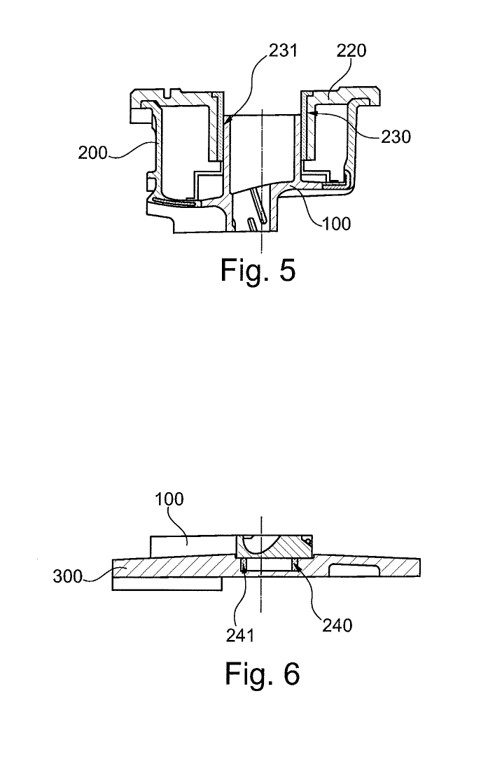

FIG. 5 shows an assembled guide vane in the region of the outer platform, wherein the assembly between airfoil 100 and outer platform 200 resp. airfoil carrier 220 is made by a ceramic bush 230. This joint 231 may be mechanically loaded, no absolutely tightness is required. The remaining structure of the assembly corresponds essentially to the arrangement, as seen in FIG. 4.

The outer platform 200 is cast, forged or manufactured in metal sheet or plate. The outer platform is consumable in relation to predetermined cycles and replaced frequently at specified maintenance periods and may be mechanically decoupled from the guide vane airfoil, wherein the outer platform may be supplementary mechanically connected to the airfoil carrier, using force closure elements, namely bolts. The outer platform may be coated with CMC or ceramic materials.

FIG. 6 shows an assembled guide vane in the region of the inner platform 300, wherein the assembly between airfoil 100 and inner platform 300 is made by a ceramic bush 240. This joint 241 may be mechanically loaded, no absolute tightness is required. The remaining structure of the assembly corresponds essentially to the arrangement, as seen in FIG. 4.

The inner platform 300 is cast, forged or manufactured in metal sheet or plate. The outer platform is consumable and replaced at specified maintenance periods and may be mechanically decoupled from the guide vane airfoil, wherein the inner platform may be supplementarily mechanically connected to the airfoil carrier, using force closure elements, namely bolts. The inner platform may be coated with CMC or ceramic materials.

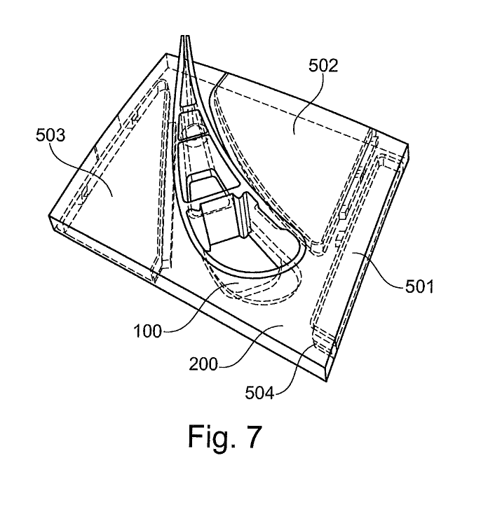

FIG. 7 shows a platform 200 of a guide vane assembly with inserts and/or mechanical interlocks 501-503 optionally sealed by HT ceramics. This arrangement may involve inner and/or outer platform, and/or airfoil, and/or airfoil carrier, and/or outer hot gas path liner, and are disposed along or within the thermal stress areas, namely the flow-charged zone of the guide vane. The insert element and/or mechanical interlock form the respective flow-charged zone are inserted at least in a force-fitting manner into appropriately designed recesses or in the manner of a push loading drawer with additional fixing means 504. Additionally, the insert element and/or mechanical interlock may be sealed by HT ceramics.

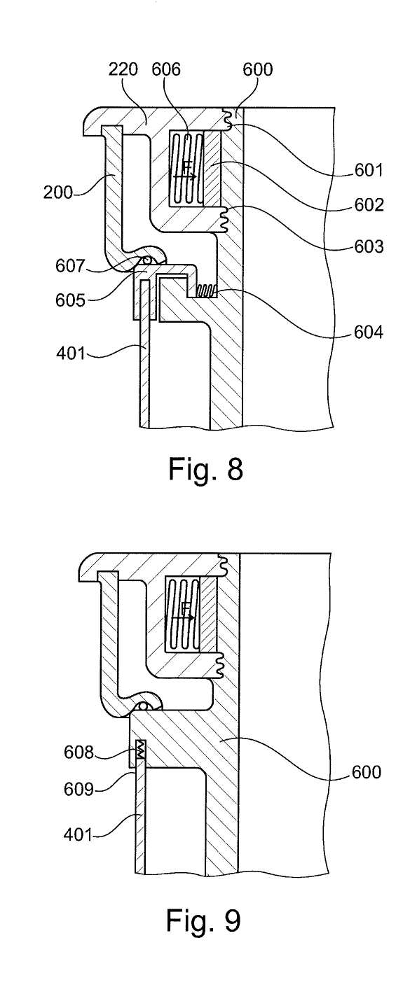

FIG. 8 shows a joining technology in the range of guide blade airfoil carrier and outer shell assembly. Specifically, FIG. 8 shows the outer platform 200 and guide vane airfoil carrier 220; additionally a spring 606 to exert a force with respect to an insert 602 in the range of the spar 600, wherein the spring is actively connected to sliding bed configuration of locking systems 601, 603. A further spring 604 results actively connected to a metallic clamp 605 and the spar 600, and indirectly to the outer shell 401. A ring 607 provides the seal between the outer platform 200 and metallic clamp 605.

FIG. 9 shows a further joining technology in the range of guide blade airfoil carrier and outer shell assembly. The assembly in connection with the outer shell 401 with respect to the spar 600 comprises a spring 8 and a metallic cover element 609.

Important aspects of the shown joinings in connection with FIGS. 8 and 9 are as follows: the CMC or metallic outer shell is necessary to protect the sensitive metallic spar. Avoiding mechanical load, especially on the CMC, reduces risk of failure. The concept involves an interference fit with ceramic bush and compensator (spring) and fixation of CMC or metallic shell with metallic clamp and spring (FIG. 8) or by spring and metallic cover (FIG. 9).

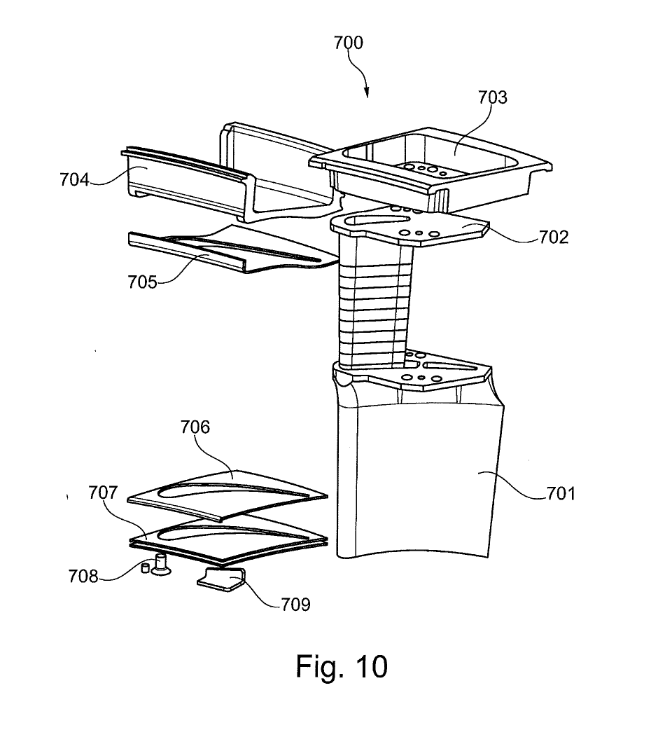

FIG. 10 shows a typical arrangement of the guide vane with a metallic shell 700. The elements shown in FIG. 10 are easily understood by a person skilled in the art, namely: 701 metallic shell; 702 spar; 703 airfoil carrier; 704 outer platform carrier; 705 outer platform hot gas liner; 706 inner platform hot gas liner; 707 inner platform carrier; 708 bolt and pin; 709 patch. The technical aspects of the elements result from the preceding figures and the associated description. The inner platform comprises a brazed/welding patch. The hot gas liner and hot gas carrier compose a brazed structure. The outer platform includes an impingement cooling. The outer platform comprises a brazed/welding structure. The spar comprises a sealing structure with respect to the airfoil. The outer platform includes securing/and rotating elements.

Although this invention has been shown and described with respect to detailed embodiments thereof, it will be appreciated and understood by those skilled in the art that various changes in form and detail thereof may be made without departing from the spirit and scope of the claimed invention.

### LIST OF REFERENCES NUMEROUS

100 Airfoil

101 Guide vane leading edge

102 guide vane trailing edge

103 Cooling passage

104 Cooling passage

105 Cooling passage

106 Guide vane trailing edge side cooling passage

107 Guide vane trailing edge side cooling passages

108a Heat transfer accelerating elements

108b Heat transfer accelerating elements

109a Heat transfer accelerating elements

109b Heat transfer accelerating elements

110 Pressure side

120 Suction side

130 Swirl up

140 Recess

150 Lug

200 Outer platform

201 Mounting hook

202 Mounting hook

210 Connection

220 Airfoil carrier

221 Protective liner

222 Joint

223 Protective liner

224 Mechanical loaded means

225 Joint

230 Ceramic bush

231 Joint

240 Ceramic bush

241 Joint

300 Inner platform

400 Shell structure

401 Outer shell, CMC shell

501 Insert element or mechanical interlock

502 Insert element or mechanical interlock

503 Insert element or mechanical interlock

504 Fixing means

600 Spar, CMC spar

601 Locking system

602 Insert, CMC insert

603 Locking system

604 Spring

605 Metallic clamp of CMC shell

606 Spring

607 Sealing ring

608 Spring

609 Metallic cover of CMC shell

700 Concept guide vane

701 Metallic shell

702 Spar

703 Airfoil carrier

704 Outer platform carrier

705 Outer platform hot gas liner

706 Inner platform hot gas liner

707 Inner platform carrier

708 Bolt and pin

709 Patch

1. A guide vane assembly of a turbomachine based on a modular structure, wherein the guide vane comprises:
at least one airfoil, an inner platform, an outer platform, wherein the guide vane airfoil and/or platforms each have at its one ending provisions for connection of the guide vane elements among each other, wherein the connections of guide vane elements among each other are each configured as a detachable, permanent or semi-permanent fixation with respect to a radial or quasi-radial extension of the airfoil compared to a rotor axis of a turbomachine, wherein the assembling of the airfoil with respect to at least one platform is based on a force-fit and/or a form-fit connection, or the assembling of the airfoil with respect to at least one platform is based on the use of a metallic and/or ceramic fitting surface, or the assembling of the airfoil with respect to at least one platform is based on force closure means with a detachable, permanent or semi-permanent fixation, wherein at least the guide vane airfoil or an alternative base structure of the airfoil includes at least one flow-charged outer hot gas path liner, which encases at least one part of the guide vane airfoil, wherein the flow-charged outer hot gas path liner is connected to the guide vane airfoil or alternative base structure of the airfoil by using a shrinking joint.

2. The guide vane assembly according to claim 1, wherein the guide vane elements comprise:
at least one airfoil carrier, which forms at least one flow member of the outer platform.

3. The guide vane assembly according to claim 1, wherein the inner and/or the outer platform are assembled with at least two joined parts with placing of the airfoil between said two parts.

4. The guide vane assembly according to claim 1, wherein metallic and/or ceramic fitting surfaces form components of adjacent body parts.

5. The guide vane assembly according to claim 1, wherein the flow-charged outer hot gas path liner encases integrally or partially the outer contour of the airfoil.

6. The guide vane assembly according to claim 1, wherein the alternative base structure of the airfoil is formed as a spar.

7. The guide vane assembly according to claim 1, wherein the outer contour of the airfoil is an independent flow-charged part, being directly or indirectly actively connected to the leading edge of the airfoil of the guide vane.

8. The guide vane assembly according to claim 1, wherein the flow-charged outer hot gas path liner encases integrally the outer contour of the airfoil, or the flow-charged outer hot gas path liner encases partially the outer contour of the airfoil, or the flow-charged outer hot gas liner encases integrally a sub-structure, wherein the sub-structure is formed by the form of a spar.

9. The guide vane assembly according to claim 1, wherein the flow-charged outer hot gas path liner encases integrally the outer contour of the airfoil, wherein the outer hot gas path liner is formed by the form of an integrally or a segmented body.

10. The guide vane assembly according to claim 1, wherein the first flow-charged outer hot gas path liner has inside a second or intermediate non flow-charged liner or a partially flow-charged liner.

11. The guide vane assembly according to claim 1, wherein the first flow-charged outer hot gas liner has inside a second or intermediate non flow-charged or partially flow-charged liner, wherein the outer and the intermediate liners are arranged adjacently to each other in a mutually spaced manner.

12. The guide vane assembly according to claim 1, wherein at least the first flow-charged outer hot gas path liner encases integrally the outer contour of the airfoil, wherein the first outer hot gas path liner comprises:
at least two bodies, forming completely or partially the outer contour of the guide vane airfoil.

13. The guide vane assembly according to claim 1, wherein at least the first outer hot gas path liner encases integrally the outer contour of the airfoil, wherein the outer hot gas path liner comprises:
at least two bodies, forming the outer contour of the airfoil, and wherein these bodies are brazed or welded along their radial interface.

14. The guide vane assembly according to claim 1, wherein at least the first outer hot gas path liner encases integrally the outer contour of the airfoil, wherein the outer hot gas path liner comprises:
at least two bodies, forming the outer contour of the airfoil, and wherein these bodies have radial or quasi-radial gaps, which are filled with a seal and/or a ceramic material.

15. The guide vane assembly according to claim 1, wherein the means for an interchangeable connection of vane elements, namely between airfoil, inner platform, outer platform comprise:
reciprocal lugs or recesses for a friction-locked bonding or permanent connection.

16. The guide vane assembly according to claim 1, wherein at least one platform comprises:
at last one insert element or mechanical interlock and/or an additional thermal barrier coating along thermal stress areas.

17. The guide vane assembly according to claim 1, wherein at least one platform and/or airfoil and/or airfoil carrier and/or outer hot gas path liner comprise:
at least one insert element and/or mechanical interlock along or within thermal stress areas, wherein the insert element and/or mechanical interlock.

18. The guide vane assembly according to claim 17, wherein the insert element and/or mechanical interlock, which form a respective flow-charged zone, are inserted at least in a force fitting manner into appropriately designed recesses or as a push loading drawer with additional fixing means.

19. The guide vane assembly according to claim 18, wherein an upper surface of the insert element and/or mechanical interlock, which form the respective flow-charged zone, are sealed by HT ceramics.

20. The guide vane assembly according to claim 1, wherein the internal cooling path of the airfoil is actively connected to the cooling structure of the first flow-charged outer hot gas path liner, the second outer hot gas path liner and/or the inner and outer platforms, wherein the cooling is configured for a convective and/or film and/or effusion and/or impingement cooling method.

21. The guide vane assembly according to claim 1, wherein the guide vane airfoil has a swirled aerodynamic profile in a radial direction.

22. The vane guide assembly according to claim 1, wherein the assembly in a range of the airfoil carrier and outer shell comprises:
at least one compensator for thermal dilations.

23. A method for assembling a guide vane of a turbomachine based on a modular structure, wherein the guide vane elements include at least an airfoil, an inner platform, an outer platform, wherein the guide vane airfoil and/or platforms each have at its one ending provisions for connection of the guide vane elements among each other, wherein the connections of the guide vane elements among each other are each configured as a detachable, permanent or semi-permanent fixation with respect to a radial or quasi-radial extension of the airfoil compared to a rotor axis of a turbomachine, wherein the method comprises:
assembling of the airfoil with respect to at least one platform based on a force-fit and/or a form-fit connection, or assembling of the airfoil with respect to at least one platform based on use of a metallic and/or ceramic fitting surface, or assembling of the airfoil with respect to at least one platform based on force closure means with a detachable, permanent or semi-permanent fixation, wherein at least the guide vane airfoil or an alternative base structure of the airfoil includes at least one flow-charged outer hot gas path liner, which encases at least a part of the guide van airfoil, wherein the flow-charged outer hot gas path liner is connected with respect to the guide vane airfoil or alternative base structure of the airfoil by using a shrinking joint.

24. A method for assembling a guide vane of a turbomachine based on a modular structure, wherein the guide vane elements include at least an airfoil, an inner platform, an outer platform, wherein the guide vane airfoil and/or platforms have at its one ending provisions for connection of the guide vane elements among each other, wherein the connection of the guide vane elements among each other are each configured as a detachable, permanent or semi-permanent fixation with respect to a radial or quasi-radial extension of the airfoil compared to a rotor axis of a turbomachine, wherein the method comprises:
assembling of the airfoil with respect to at least one platform based on a force-fit and/or a form-fit connection, or the assembling of the airfoil with respect to at least one platform is based on the use of a metallic and/or ceramic fitting surface, or assembling of the airfoil with respect to at least one platform based on force closure means with a detachable, permanent or semi-permanent fixation, wherein at least the guide vane airfoil or an alternative base structure of the airfoil includes at least one flow-charged outer hot gas path liner, which encases at least one part of the defined guide vane airfoil, wherein the platforms include at least one insert element or mechanical interlock and/or additional thermal barrier coating along thermal stress areas.

25. A method for assembling a guide vane of a turbomachine based on a modular structure, wherein the guide vane elements include at least an airfoil, an inner platform, an outer platform, wherein the guide vane airfoil and/or platforms each have at its one ending provisions for connection of the guide vane elements among each other, wherein the connections of the guide vane elements among each other are each configured as a detachable, permanent or semi-permanent fixation with respect to a radial or quasi-radial extension of the airfoil compared to a rotor axis of a gas turbine, wherein the method comprises:
assembling of the airfoil with respect to at least one platform based on a force-fit and/or a form-fit connection, or the assembling of the airfoil with respect to at least one platform is based on use of a metallic and/or ceramic fitting surface, or assembling of the airfoil with respect to at least one platform based on force closure means with a detachable, permanent or semi-permanent fixation, wherein at least the guide vane airfoil or an alternative base structure of the airfoil includes at least one flow-charged outer hot gas path liner, which encases at least one part of the defined guide vane airfoil, wherein platforms and/or airfoil and/or airfoil carrier and/or outer hot gas path liner include at least one insert element and/or mechanical interlock along or within the thermal stress areas.

26. The method for assembling a guide vane according to claim 23, wherein the insert element and/or mechanical interlock, forming the respective flow-charged zone, are inserted at least in a force-fitting manner into appropriately designed recesses or as a push loading drawer with additional fixing means.

27. The method for assembling a guide vane according to claim 23, wherein an upper surface of the insert element and/or mechanical interlock, which form the respective flow-charged zone, is sealed by HT ceramics.
